(19) United States
(12) Patent Application Publication
(10) Pub. No.: US 2024/0415154 A1
(43) Pub. Date: Dec. 19, 2024

(54) FAVA PROTEIN COMPOSITION

(71) Applicant: Coöperatie Koninklijke Cosun U.A., Breda (NL)

(72) Inventors: Marlies Elisabeth Johanna Geerts, Dinteloord (NL); Joannes Gerardus Maria van Nispen, Dinteloord (NL)

(73) Assignee: Coöperatie Koninklijke Cosun U.A., Breda (NL)

(21) Appl. No.: 18/704,935

(22) PCT Filed: Nov. 1, 2022
(86) PCT No.: PCT/EP2022/080429

§ 371 Date: Apr. 26, 2024

(30) Foreign Application Priority Data
Nov. 1, 2021 (EP) 21205789.7

(51) Int. Cl. A23L 11/50; A23J 1/14; A23L 27/60

(52) U.S. Cl. CPC A23L 11/50; A23J 1/14; A23L 27/60

(57) ABSTRACT

The invention pertains to a fava protein composition comprising:
fava globulins and fava albumins; and
at most 2.5 ppm hexanal, based on the weight of the protein in the fava protein composition,
   wherein the solubility of the protein in water at a pH of 7 and at a temperature of 20° C. is at least 55%, and wherein the weight ratio of fava albumins to fava globulins in the fava protein composition is between 1:4 and 1:20.

The invention further pertains to a method of extracting fava proteins from de-hulled fava beans.

### TECHNICAL FIELD OF THE INVENTION

The present invention relates to fava protein compositions and to a method of extracting fava proteins from de-hulled fava beans.

### BACKGROUND OF THE INVENTION

Fava proteins are extracted from fava beans, also referred to as faba beans, horse beans or broad beans. Fava protein isolates are generally recognized as safe (GRAS according to GRN 879). In Notification GRN 879, the fava protein isolate is obtained through acid precipitation with which mainly globulins are collected and the soluble albumins are discarded.

Vogelsang-O'Dwyer (2020; doi:10.3390/foods9030322) describes two fava protein products, of which one (referred to as FPR) is obtained via dry fractionation (using milling and clarification) and the other (referred to as FPI) is obtained using acid precipitation at a pH of 4.8. Vogelsang reports that the protein solubility observed for FPR is better than the protein solubility observed for FPI. Especially at pH of 3, the protein solubility for both FPR and FPI does not exceed 40%, and at pH of 7 the solubility for FPR is around 80% and for FPI around 30%. It is further noted that the vicine level in FPR is almost 8000 ppm, based on dry weight, which is undesirably high, as vicine may cause favism.

Karaca (2011; doi:10.1016/j.foodres.2011.06.012) compares emulsifying properties of faba bean protein isolates produced by isoelectric precipitation (referred to as FbPI-isoelectric precipitation) and salt extraction (referred to as FbPI-salt extraction). Isoelectric precipitation was performed at pH 4.50. Karaca explains that isoelectric precipitation mainly precipitates globulins, since the pI value (isoelectric point) for globulins is ˜4.50, whereas the pI value for albumins is ˜6.00. Accordingly, faba bean protein isolates produced using isoelectric precipitation typically do not or only hardly comprise albumins which remain soluble during the precipitation process. Karaca describes that protein isolates produced using salt extraction typically comprise a mixture of globulins and albumins. The protein solubility of the FbPI-salt extraction was only about 52% at pH of 7.00.

Vogelsang-O'Dwyer and Karaca describe that the main proteins found in legume seeds, such as fava beans, are globulins and albumins. Globulins represent between about 70 and 78 wt % of the protein found in legume seeds, whereas albumins constitute between about 10 and 20 wt % of the protein.

Vioque (2012; doi:10.1016/j.foodchem.2011.10.033) discloses fava protein obtained by milling whole fava beans and suspending the milled beans in water at a pH of 10.5 and subsequently performing acid precipitation at pH of 4. Although not shown by Vioque, it is expected that the solubilty of the fava protein is similar to the solubility observed by Vogelsang or even lower as the acid precipitation is performed at lower pH which may lead to less hydration of globulins.

In WO2020/51622, a process to extract proteins from fava beans is described wherein dried fava beans are milled and suspended at pH 9.3 before being centrifuged and pasteurized. After pasteurization, the milk-like liquid is fed through an ultrafiltration unit, after which the retentate is dried by evaporation. This process uses dried fava beans which still include the seed coat and embryo radicle; in this way, phenols, polyphenols, saponins and tannins are introduced which may cause browning through enzymatic and/or auto-oxidation, which is undesirable, especially for use in food products where colour is important. Moreover, the high pH of the suspension may lead to further browning of the fava protein product. Such high pHs may also lead to the formation of lysinoalanine (LAL), which reduces the nutritional value of the protein. In addition, the pasteurization step is performed before the ultrafiltration step which allows microbes to proliferate and may eventually lead to expression of undesirable toxins.

J. R. Vose, Cereal Chemistry, 57(6), 1980, pp 406-410, discloses different processes wherein horse bean protein isolates are produced. In all processes, horse bean seeds were dehulled, the seeds were subjected to pin milling to provide a flour, water (pH 8.5) was added to the flour to provide a slurry, and the resulting slurry was screened to remove the fibre fraction. The screened extract was either (i) passed through a series of five hydrocyclone units using a countercurrent wash system or (ii) centrifuged to recover a starch fraction and a supernatant that was recentrifuged to remove fine fiber and dispersed protein. The liquor fraction from either (i) the cyclones or (ii) from the centrifuge was further purified to provide horsebean protein isolates. Protein was isolated from the liquor fractions using (a) isoelectric precipitation, (b) ultrafiltration or (c) diafiltration. The diafiltration experiment described in Vose is not enabled because the fluxes of 2200 L/(m²·h) through the membrane are not feasible. The ultrafiltration process (b) used a 50 kDa polysulfone membrane operated at 40-45° C. for 6 to 7 hours. The ultrafiltration retentate was spray-dried to provide a protein isolate. In process (a), protein was precipitated by adjusting the pH to 4.4-4.6, collecting the precipitated protein by centrifugation, diluting the protein cake to 14% solids, neutralizing the slurry with NaOH and spray drying to provide a protein isolate. It is described in Vose that the ultrafiltration process (b) resulted in a horse bean protein isolate comprising, based on dry weight, 94.1 wt % protein, a protein solubility at pH 3 of about 35% and a protein solubility at pH 7 of about 30%. Ultrafiltration process (b) resulted in 88 wt % recovery of the protein present in the feed stream. It is described that soluble proteins cross the membrane and that albumin is an example of a soluble protein. The precipitation process (a) resulted in a horsebean protein isolate comprising, based on dry weight, 91.2 wt % protein, a protein solubility at pH 3 of about 40% and a protein solubility at pH 7 of about 65%. Process (a) resulted in precipitation of 82% of the protein extracted from the flour at pH 8.5.

GB1471014A describes a process for obtaining protein isolates from vegetables, among which is horse beans. Example 3 of GB1471014A describes a process wherein protein was extracted from finely ground whole horse bean seeds at pH 11 and a temperature of about 35° C. for 30 minutes. The resulting slurry was clarified by centrifugation. The supernatant comprising the soluble proteins was subjected to dead-end filtration using a 30 kDa membrane. Since fava bean albumins typically have molecular weights of <15 kDa, dead-end filtration using a 30 kDa membrane results in albumins crossing the membrane into the permeate.

WO2020/193668A1 discloses field bean protein isolates having a solubility of less than 25% at a minimum pH of 7 and a method for the production thereof comprising isoelectric precipitation at a pH of about 4.5. It is described in WO2020/193668A1 that the protein composition, mostly globulin, coagulates and precipitates within the solution and is separated off by centrifugation technique. The residual solution obtained comprises sugars, salts and albumins and can be processed separately.

The known processes to obtain fava protein compositions generally lead to compositions with inferior solubility and inferior functional properties.

It is an objective of the present invention to provide a novel fava protein composition.

### SUMMARY OF THE INVENTION

In a first aspect, the invention provides a fava protein composition comprising:
fava globulins and fava albumins; and
at most 2.5 ppm hexanal, based on the weight of the protein in the fava protein composition,
   wherein the solubility of the protein in water at a pH of 7 and at a temperature of 20° C. is at least 55%, and
   wherein the weight ratio of fava albumins to fava globulins in the fava protein composition is between 1:4 and 1:20.

The fava protein composition of the invention exhibits good emulsifying properties. The emulsifying properties of the inventive composition allow for a wide variety of uses, e.g. in emulsions and in dispersions. The fava protein composition of the invention further has a water solubility generally exceeding the solubility of conventional fava protein concentrates and isolates. The solubility profile as a function of pH is also very favourable, in particular its solubility at low pH, preferably at a pH below 4, which allows use in acidified emulsification such as in mayonnaise. Without being bound by theory, it is believed that the fava protein composition of the invention comprises considerable amounts of native protein, which is not or only partially denatured, agglomerated or otherwise structurally or chemically modified; such modifications generally lead to a (much) lower emulsifying activity and considerably lower solubility. The amount of native protein is generally significantly higher than in conventional fava proteins compositions. Conventional fava protein compositions which were prepared using an acid precipitation step are not considered to be purely native proteins but proteins that are at least partially and/or predominantly agglomerated and/or structurally altered, causing their properties to change. Moreover, such acid precipitated fava proteins generally do not comprise albumins. The presence of albumins provide improved emulsifying properties to the inventive fava protein. An additional advantage of the fava protein composition of the invention is the low concentration of hexanal, which renders the taste of the fava protein composition to be better than conventional fava protein compositions. Hexanal is generally perceived as a predominantly present off-flavour component. Next to hexanal, other off-flavour components are generally present, and hexanal is for the purpose of the present application considered as a marker for the off-flavour components, which means that if the amount of hexanal in the protein composition is below 2.5 ppm, the other off-flavour components are correspondingly low (and generally present in even lower amounts). Consequently, the fava protein composition of the invention, when used in food applications, does not provide an off-taste, including beany taste, to the resulting food product. The inventors found that the commercial fava protein compositions generally give a pronounced beany, earthy and cardboard taste to the food product. In addition, the fava protein composition of the invention is generally considerably more white than conventional fava protein isolates. The colour of the composition is generally substantially white. The inventive fava protein composition is non-toxic and readily biodegradable. Hence, the inventive fava protein compositions can be used in food and feed applications. The fava protein composition of the invention may replace at least partially or even completely natural emulsifiers such as octenyl succinic anhydride modified starch and gum Arabic; or synthetic polymeric emulsifiers such as polyacrylate and ethoxylated sorbitan esters (Tween® surfactants). In replacing gum Arabic, moreover lower amounts can be used. In replacing synthetic polymeric emulsifiers, these polymeric emulsifiers generally are synthesized from fossil fuel-derived monomers, which is generally undesirable. The fava protein composition provides a natural source and is a greener, more eco-friendly solution. Additionally, the fava protein composition may at least partially or even completely replace animal-derived proteins such as chicken egg protein and milk proteins.

In a second aspect, the invention provides a method of extracting fava proteins from de-hulled fava beans comprising the steps of:
(a) milling de-hulled fava beans to form fava bean particles;
(b) adding water to the fava bean particles to form a suspension;
(c) removing solids from the suspension to form a liquid;
(d) subjecting the liquid to ultrafiltration to form a retentate;
(e) optionally pasteurizing the retentate; and
(f) optionally removing water from the retentate, preferably to form solid particles.

### BRIEF DESCRIPTION OF THE FIGURE

FIG. 1 depicts results of a sensory analysis of a fava protein composition according to the invention and of commercial (comparative) fava bean protein isolates.

### DETAILED DESCRIPTION

In a first aspect, the invention concerns a fava protein composition comprising:
fava globulins and fava albumins; and
at most 2.5 ppm hexanal, based on the weight of the protein in the fava protein composition,
   wherein the solubility of the protein in water at a pH of 7 and at a temperature of 20° C. is at least 55%, and
   wherein the weight ratio of fava albumins to fava globulins in the fava protein composition is between 1:4 and 1:20.

The fava protein composition comprises fava globulins and fava albumins and at most 2.5 ppm hexanal, based on the weight of the protein in the fava protein composition, meaning that the composition can also comprise further ingredients, such as for example non-fava proteins. Hence, the feature ‘based on the weight of the protein in the fava protein composition’ concerns the weight of all proteins in the fava protein composition. Likewise, the feature ‘the solubility of the protein’ concerns the solubility of all proteins in the fava protein composition.

In a preferred embodiment, the fava protein composition as defined hereinbefore has a dry matter content of between 91 and 99 wt %, and comprises, based on dry weight of the fava protein composition:
80-95 wt % of fava protein, such as between 82 and 88 wt %;
less than 7 wt % of fats and lipids, such as between 0.1 and 3 wt %;
less than 7 wt % of carbohydrates, such as between 0.1 and 5 wt %; and
less than 9 wt % of ash, such as between 0.1 and 6 wt %,
   wherein fava albumins constitute between 5 and 20 wt % of the fava proteins in the fava protein composition, preferably between 5.5 and 18 wt %, more preferably between 6 and 15 wt %, such as between 7 and 13 wt % or between 8 and 11 wt %.

In another preferred embodiment, the fava protein composition as defined hereinbefore has a dry matter content of between 91 and 99 wt %, and comprises, based on dry weight of the fava protein composition:
80-95 wt % of fava protein, such as between 82 and 88 wt %;
less than 7 wt % of fats and lipids, such as between 0.1 and 3 wt %;
less than 7 wt % of carbohydrates, such as between 0.1 and 5 wt %; and
less than 9 wt % of ash, such as between 0.1 and 6 wt %,
   wherein the fava protein composition comprises more than 75 wt % of fava globulins and fava albumins, based on the weight of the fava protein composition, preferably more than 80 wt %, more preferably more than 83 wt %, even more preferably more than 85 wt %, such as more than 87 wt %.

In yet another preferred embodiment, the fava protein composition as defined hereinbefore has a dry matter content of between 91 and 99 wt %, and comprises, based on dry weight of the fava protein composition:
80-95 wt % of fava protein, such as between 82 and 88 wt %;
less than 7 wt % of fats and lipids, such as between 0.1 and 3 wt %;
less than 7 wt % of carbohydrates, such as between 0.1 and 5 wt %; and
less than 9 wt % of ash, such as between 0.1 and 6 wt %,
   wherein the weight ratio of fava albumins to fava globulins in the fava protein composition is between 1:5 and 1:18, preferably between 1:6 and 1:15, more preferably between 1:7 and 1:13, such as between 1:8 and 1:11.

### Hexanal Content

The fava protein composition of the present invention comprises at most 2.5 ppm hexanal, based on the weight of the protein in the fava protein composition. The hexanal content of a fava protein composition is determined using the measuring protocol as defined in the experimental section.

Preferably, the fava protein composition comprises at most 2 ppm hexanal, based on the weight of the protein in the fava protein composition, more preferably at most 1.5 ppm, even more preferably at most 1.2 ppm, yet more preferably at most 1 ppm, even more preferably at most 900 ppb, even more preferably at most 800 ppb, even more preferably at most 700 ppb, yet more preferably at most 600 ppb, such as at most 500 ppb, at most 450 ppb, at most 400 ppb, at most 350 ppb or at most 300 ppb.

Preferably, the fava protein composition comprises at least 1 ppb hexanal, based on the weight of the protein in the fava protein composition, more preferably at least 10 ppb, even more preferably at least 50 ppb, such as at least 100 ppb.

In another preferred embodiment, the fava protein composition comprises between 1 ppb and 2.5 ppm hexanal, based on the weight of the protein in the fava protein composition, more preferably between 10 ppb and 1.5 ppm, such as between 50 ppb and 1 ppm, between 75 ppb and 600 ppb or between 100 ppb and 400 ppb.

Preferably, the fava protein composition comprises at most 2 ppm hexanal, based on the weight of the fava protein in the fava protein composition, more preferably at most 1.5 ppm, even more preferably at most 1.2 ppm, even more preferably at most 1 ppm, even more preferably at most 900 ppb, even more preferably at most 800 ppb, even more preferably at most 700 ppb, even more preferably at most 600 ppb, such as at most 500 ppb, at most 450 ppb, at most 400 ppb, at most 350 ppb or at most 300 ppb.

Preferably, the fava protein composition comprises at least 1 ppb hexanal, based on the weight of the fava protein in the fava protein composition, more preferably at least 10 ppb, even more preferably at least 50 ppb, such as at least 100 ppb hexanal.

In another preferred embodiment, the fava protein composition comprises between 1 ppb and 2.5 ppm hexanal, based on the weight of the fava protein in the fava protein composition, more preferably between 10 ppb and 1.5 ppm, such as between 50 ppb and 1 ppm, between 75 ppb and 600 ppb or between 100 ppb and 400 ppb.

Preferably, the fava protein composition comprises at most 2 ppm hexanal, based on the weight of the combined amounts of the fava globulins and fava albumins in the fava protein composition, more preferably at most 1.5 ppm, even more preferably at most 1.2 ppm, even more preferably at most 1 ppm, even more preferably at most 900 ppb, even more preferably at most 800 ppb, even more preferably at most 700 ppb, even more preferably at most 600 ppb, such as at most 500 ppb, at most 450 ppb, at most 400 ppb, at most 350 ppb or at most 300 ppb.

Preferably, the fava protein composition comprises at least 1 ppb hexanal, based on the weight of the combined amounts of the fava globulins and fava albumins in the fava protein composition, more preferably at least 10 ppb, even more preferably at least 50 ppb, such as at least 100 ppb.

In another preferred embodiment, the fava protein composition comprises between 1 ppb and 2.5 ppm hexanal, based on the weight of the combined amounts of the fava globulins and fava albumins in the fava protein composition, more preferably between 10 ppb and 1.5 ppm, such as between 50 ppb and 1 ppm, between 75 ppb and 600 ppb or between 100 ppb and 400 ppb.

As indicated above, hexanal serves as a marker for all off-flavour components, i.e. if the amount of hexanal in the composition is low, the overall amount of off-flavour components is generally correspondingly low. In the method according to the second aspect (described in more detail below), the formation of hexanal and other off-flavour components is less as generally less or no oxidation occurs. Moreover, hexanal and the off-flavour components are removed in the ultrafiltration step. As a consequence of the low level of hexanal and of other off-flavour components, the typical beany flavour observed for conventional fava protein compositions is not present in food products, like yoghurt or ice cream, comprising the fava protein composition of the invention.

### Vicine

In one embodiment, the fava protein composition of the present invention comprises at most 1000 ppm vicine, based on the weight of the protein in the fava protein composition.

Preferably, the fava protein composition comprises at most 900 ppm vicine, based on the weight of the protein in the fava protein composition, more preferably at most 800 ppm, even more preferably at most 700 ppm, and most preferably at most 600 ppm, and preferably at least 1 ppb, more preferably at least 10 ppb, even more preferably at least 50 ppb, and most preferably at least 100 ppb.

In another embodiment, the fava protein composition of the present invention comprises at most 1000 ppm vicine, based on the weight of the fava protein in the fava protein composition.

Preferably, the fava protein composition comprises at most 900 ppm vicine, based on the weight of the fava protein in the fava protein composition, more preferably at most 800 ppm, even more preferably at most 700 ppm, and most preferably at most 600 ppm, and preferably at least 1 ppb, more preferably at least 10 ppb, even more preferably at least 50 ppb, and most preferably at least 100 ppb.

In another embodiment, the fava protein composition of the present invention comprises at most 1000 ppm vicine, based on the weight of the combined amounts of the fava globulins and fava albumins in the fava protein composition.

Preferably, the fava protein composition comprises at most 900 ppm vicine, based on the weight of the combined amounts of the fava globulins and fava albumins in the fava protein composition, more preferably at most 800 ppm, even more preferably at most 700 ppm, and most preferably at most 600 ppm, and preferably at least 1 ppb, more preferably at least 10 ppb, even more preferably at least 50 ppb, and most preferably at least 100 ppb.

Vicine together with convicine may cause favism in individuals with a glucose-6-phosphate dehydrogenase (G6PD) deficiency when vicine and convicine are consumed in too large amounts. The inventive fava protein composition can be consumed as a replacement of current commercial protein isolates without the risk of hemolytic effects in individuals with G6PD deficiency. Fava protein compositions prepared using an acid precipitation step generally have a low level of vicine and convicine. The method according to the second aspect (described below) effectively removes vicine and convicine from the fava protein, in particular the ultrafiltration step is very effective for vicine/convicine removal.

### Protein Content

In an embodiment, the fava protein composition comprises at least 60 wt % protein, based on the total weight of the composition. As explained hereinbefore, this protein can also comprise non-fava protein.

Preferably, the fava protein composition comprises at least 70 wt % of protein, more preferably at least 75 wt %, even more preferably at least 80 wt %, still more preferably at least 83 wt %, yet more preferably at least 85 wt % and most preferably at least 90 wt %, and preferably at most 99 wt % of protein, more preferably at most 97 wt %, even more preferably at most 96 wt %, and most preferably at most 95 wt %, based on the total weight of the fava protein composition.

In another embodiment, the fava protein composition comprises between 75 and 98 wt % of protein, based on the weight of the fava protein composition, preferably between 80 and 95 wt %, more preferably between 83 and 93 wt %, such as between 84 and 90 wt %.

Preferably, the fava protein composition comprises at least 70 wt % of fava protein, more preferably at least 75 wt %, even more preferably at least 80 wt %, still more preferably at least 83 wt %, yet more preferably at least 85 wt % and most preferably at least 90 wt %, and preferably at most 99 wt % of fava protein, more preferably at most 97 wt %, even more preferably at most 96 wt %, and most preferably at most 95 wt %, based on the total weight of the fava protein composition.

In another embodiment, the fava protein composition comprises between 75 and 98 wt % of fava protein, based on the weight of the fava protein composition, preferably between 80 and 95 wt %, more preferably between 83 and 93 wt %, such as between 84 and 90 wt %.

Preferably, the fava protein composition comprises at least 70 wt % of fava globulins and fava albumins, more preferably at least 75 wt %, even more preferably at least 80 wt %, still more preferably at least 83 wt %, yet more preferably at least 85 wt % and most preferably at least 90 wt %, and preferably at most 99 wt % of fava globulins and fava albumins, more preferably at most 97 wt %, even more preferably at most 96 wt %, and most preferably at most 95 wt %, based on the total weight of the fava protein composition. As will be appreciated by those skilled in the art, these weight percentages concern the combined amounts of fava globulins and fava albumins.

In another embodiment, the fava protein composition comprises between 75 and 98 wt % of fava globulins and fava albumins, based on the weight of the fava protein composition, preferably between 80 and 95 wt %, more preferably between 83 and 93 wt %, such as between 84 and 90 wt %.

As described hereinbefore, globulins represent between about 70 and 78 wt % of the protein found in fava beans, whereas albumins constitute between about 10 and 20 wt % of the protein. The weight ratio of fava albumins to fava globulins in the fava protein composition is between 1 (fava albumins):4 (fava globulins) and 1:20, preferably between 1:5 and 1:18, more preferably between 1:6 and 1:15, even more preferably between 1:7 and 1:13, such as between 1:8 and 1:11.

In another embodiment, fava albumins constitute between 5 and 20 wt % of the proteins, preferably of the fava proteins, in the fava protein composition, preferably between 5.5 and 18 wt %, more preferably between 6 and 15 wt %, such as between 7 and 13 wt % or between 8 and 11 wt %.

The fava protein composition includes both concentrates and isolates. Preferably, the fava protein composition is a protein isolate. In another preferred embodiment, the fava protein composition is a protein isolate or concentrate, more preferably a protein isolate, obtained by a wet fractionation process Various methods have been described in the literature to determine the protein content. For the purposes of this application, the Kjeldahl method is used to determine the nitrogen content, which is then converted to protein content. The Kjeldahl is well established and well known to the person skilled in the art. In this application the Kjeldahl method is performed by hydrolyzing a sample using H₂SO₄ at 420° C. for 2 hours, during which the proteins will be converted to ammonium sulfate, which in turn is converted to ammonia using sodium hydroxide. The generated ammonia is distilled off and the amount of nitrogen is measured by titration. The amount of protein is calculated by multiplying the nitrogen content by the conversion factor of 6.25 (nitrogen to protein factor).

In one embodiment, the fava protein composition comprises at least 5 wt % albumin, based on the total weigh of the fava protein composition. Preferably, the fava protein composition comprises at least 6 wt % albumin, more preferably at least 7 wt %, even more preferably at least 8 wt % and most preferably at least 10 wt %, and preferably at most 20 wt % albumin, more preferably at most 17 wt % and most preferably at most 15 wt %, based on the total weight of the fava protein composition.

The skilled person will understand how to determine the albumin and globulin content. Examples of such methods includes electrophoresis and chromatography such as HPLC or size exclusion chromatography. Albumins are generally soluble in water and contribute considerably to the overall properties of the fava protein composition, e.g. emulsification and solubility. These albumins are generally removed in fava protein extracted through acid precipitation.

### Solubility

The solubility of the protein in the fava protein composition in water at a pH of 7 and at a temperature of 20° C. is at least 55%. This solubility is determined using the measuring protocol as defined in the experimental section. Preferably, the solubility of the protein in the fava protein composition in water at a pH of 7 and at a temperature of 20° C. is at least 60%, more preferably at least 70%, yet more preferably at least 80%, even more preferably at least 90%, and preferably the solubility of the protein in the fava protein composition in water at a pH of 7 and at a temperature of 20° C. is at most 99%, more preferably at most 98%, and most preferably at most 95%.

The solubility of the protein in the fava protein composition in water at a pH of 3 and at a temperature of 20° C. is preferably at least 50%. This solubility is determined using the measuring protocol as defined in the experimental section. More preferably, the solubility of the protein in the fava protein composition in water at a pH of 3 and at a temperature of 20° C. is at least 60%, even more preferably at least 70%, yet more preferably at least 80%, still more preferably at least 90%, and preferably the solubility of the protein in the fava protein composition in water at a pH of 3 and at a temperature of 20° C. is at most 99%, more preferably at most 98%, and most preferably at most 95%.

In a preferred embodiment, the solubility of the fava protein in the fava protein composition in water at a pH of 7 and at a temperature of 20° C. is at least 55%. This solubility is determined using the measuring protocol as defined in the experimental section. Preferably, the solubility of the fava protein in the fava protein composition in water at a pH of 7 and at a temperature of 20° C. is at least 60%, more preferably at least 70%, yet more preferably at least 80%, even more preferably at least 90%, and preferably the solubility of the fava protein in the fava protein composition in water at a pH of 7 and at a temperature of 20° C. is at most 99%, more preferably at most 98%, and most preferably at most 95%.

In another preferred embodiment, the solubility of the fava protein in the fava protein composition in water at a pH of 3 and at a temperature of 20° C. is at least 50%. This solubility is determined using the measuring protocol as defined in the experimental section. Preferably, the solubility of the fava protein in the fava protein composition in water at a pH of 3 and at a temperature of 20° C. is at least 60%, more preferably at least 70%, yet more preferably at least 80%, even more preferably at least 90%, and preferably the solubility of the fava protein in the fava protein composition in water at a pH of 3 and at a temperature of 20° C. is at most 99%, more preferably at most 98%, and most preferably at most 95%.

In yet another preferred embodiment, the solubility of the fava albumins and fava globulins in the fava protein composition in water at a pH of 7 and at a temperature of 20° C. is at least 55%. This solubility is determined using the measuring protocol as defined in the experimental section. As will be appreciated by those skilled in the art, these solubilities concern the combination of fava globulins and fava albumins and not the individual fava protein types. Preferably, the solubility of the fava albumins and fava globulins in the fava protein composition in water at a pH of 7 and at a temperature of 20° C. is at least 60%, more preferably at least 70%, yet more preferably at least 80%, even more preferably at least 90%, and preferably the solubility of the fava albumins and fava globulins in the fava protein composition in water at a pH of 7 and at a temperature of 20° C. is at most 99%, more preferably at most 98%, and most preferably at most 95%.

In still another preferred embodiment, the solubility of the fava albumins and fava globulins in the fava protein composition in water at a pH of 3 and at a temperature of 20° C. is at least 50%. This solubility is determined using the measuring protocol as defined in the experimental section. Preferably, the solubility of the fava albumins and fava globulins in the fava protein composition in water at a pH of 3 and at a temperature of 20° C. is at least 60%, more preferably at least 70%, yet more preferably at least 80%, even more preferably at least 90%, and preferably the solubility of the fava albumins and fava globulins in the fava protein composition in water at a pH of 3 and at a temperature of 20° C. is at most 99%, more preferably at most 98%, and most preferably at most 95%.

In one embodiment of the invention, the solubility of the fava protein composition in water and at a pH of 3 is at least 50 wt %, based on the total weight of the fava protein composition. This solubility is determined using the measuring protocol as defined in the experimental section. Preferably, the solubility of the fava protein composition in water and at a pH of 3 is at least 60 wt %, more preferably the solubility of the fava protein composition in water and at a pH of 3 is at least 70 wt %, even more preferably the solubility of the fava protein composition in water and at a pH of 3 is at least 90 wt %, and preferably the solubility of the fava protein composition in water and at a pH of 3 is at most 99 wt %, more preferably the solubility of the fava protein composition in water and at a pH of 3 is at most 98 wt %, and most preferably the solubility of the fava protein composition in water and at a pH of 3 is at most 95 wt %, based on the total weight of the fava protein composition.

Commercial fava protein isolates have a considerably lower solubility at pH 3 compared to the fava protein composition according to the invention, typically below 30 wt %, based on the total weight of the fava protein composition. The improved solubility of the inventive fava protein composition renders this composition particularly suitable for acid applications or applications comprising an acidic step. An example of such an application is mayonnaise.

In an embodiment of the invention, the solubility of the fava protein composition in water and at a pH of 7 is at least 50 wt %, based on the total weight of the fava protein composition. This solubility is determined using the measuring protocol as defined in the experimental section. Preferably, the solubility of the fava protein composition in water and at a pH of 7 is at least 60 wt %, more preferably the solubility of the fava protein composition in water and at a pH of 7 is at least 70 wt %, even more preferably the solubility of the fava protein composition in water and at a pH of 7 is at least 90 wt %, and preferably the solubility of the fava protein composition in water and at a pH of 7 is at most 99 wt %, more preferably the solubility of the fava protein composition in water and at a pH of 7 is at most 98 wt %, and most preferably the solubility of the fava protein composition in water and at a pH of 7 is at most 95 wt %, based on the total weight of the fava protein composition. Commercial fava protein isolates have a considerably lower solubility at pH 7 compared to the inventive composition, typically below 30 wt %, based on the total weight of the fava protein composition.

In another embodiment, the fava protein composition comprises at least 10 wt % native protein, based on the total weight of the fava protein composition. Preferably, the fava protein composition comprises at least 20 wt % native protein, more preferably at least 30 wt %, even more preferably at least 40 wt % and most preferably at least 50 wt %, and preferably at most 99 wt % native protein, more preferably at most 95 wt % and most preferably at least 90 wt %, based on the total weight of the fava protein composition.

In yet another embodiment, the fava protein composition comprises at least 10 wt % native protein, based on the total weight of the protein, preferably based on the total weight of the fava protein, in the fava protein composition. Preferably, the fava protein composition comprises at least 20 wt % native protein, based on the total weight of the protein, preferably based on the total weight of the fava protein, in the fava protein composition, more preferably at least 30 wt %, even more preferably at least 40 wt % and most preferably at least 50 wt %, and preferably at most 99 wt % native protein, more preferably at most 95 wt % and most preferably at least 90 wt %.

The amount of native protein can be determined with methods known in the art. Examples of such methods include Differential Scanning Calorimetry (DSC) and Circular Dichroism (CD) spectroscopy. Preferably, DSC is used to determine the amount of native protein. This method is described in Durowoju (2017; doi: 10.3791/55262).

In another embodiment, the fava protein composition comprises at most 5 wt % of ash, based on the total weight of the fava protein composition. Preferably, the fava protein composition comprises at most 4 wt % of ash, more preferably at most 3.5 wt % and most preferably at most 3 wt %, and preferably at least 0.001 wt % of ash, more preferably at least 0.01 wt % and most preferably at least 0.1 wt %, based on the total weight of the fava protein composition. The amount of ash can be determined with methods known in the art. An example of such a technique is the ICUMSA GS2/3-17 method.

In another embodiment, the fava protein composition comprises at most 5 of wt % monosaccharide and/or disaccharides, based on the total weight of the fava protein composition. Preferably, the fava protein composition comprises at most 4 wt % of mono- and/or disaccharides, more preferably at most 3.5 wt % and most preferably at most 3 wt %, and preferably at least 0.001 wt % of mono- and/or disaccharides, more preferably at least 0.01 wt % and most preferably at least 0.1 wt %, based on the total weight of the fava protein composition. The amount of mono- and/or disaccharide can be determined with methods known in the art. Examples of such methods include refractometry, specific gravity, high performance anion exclusion chromatography and infrared absorption techniques.

In another embodiment, the fava protein composition comprises at most 5 wt % of carbohydrates, based on the total weight of the fava protein composition. Preferably, the fava protein composition comprises at most 4 wt % of carbohydrates, more preferably at most 3.5 wt % and most preferably at most 3 wt %, and preferably at least 0.001 wt % of carbohydrates, more preferably at least 0.01 wt % and most preferably at least 0.1 wt %, based on the total weight of the fava protein composition.

In another embodiment, the fava protein composition comprises at most 5 wt % of starch, based on the total weight of the fava protein composition. Preferably, the fava protein composition comprises at most 4 wt % of starch, more preferably at most 3.5 wt % and most preferably at most 3 wt %, and preferably at least 0.001 wt % of starch, more preferably at least 0.01 wt % and most preferably at least 0.1 wt %, based on the total weight of the fava protein composition.

In another embodiment, the inventive fava protein composition comprises at most 7 wt % fats and lipids, based on the total weight of the fava protein composition. Preferably, the composition comprises at most 5 wt % fats and lipids, more preferably at most 2 wt % and most preferably at most 1 wt %, and preferably at least 0.001 wt % fats and lipids, more preferably at least 0.01 wt % and most preferably at least 0.1 wt %, based on the total weight of the fava protein composition. The amount of fats and lipids can be determined with methods known in the art. An example of such a technique is the ISO 6492 method.

In a further embodiment, the fava protein composition of the present invention comprises at most 2 wt % insoluble fiber, based on the total weight of the fava protein composition. Preferably, the composition comprises at most 1.5 wt % insoluble fiber, more preferably at most 1.2 wt %, and most preferably at most 1 wt %, and preferably at least 0.001 wt % insoluble fiber, more preferably at least 0.01 wt %, even more preferably at least 0.05 wt %, and most preferably at least 0.1 wt %, based on the total weight of the fava protein composition. The insoluble fiber can be determined using conventional analytical techniques. An example of such a technique is the ICUMSA GS2-19 method.

In an embodiment, the fava protein composition comprises less than 40 wt % of water, based on the total weight of the composition. Preferably, the composition comprises less than 35 wt % of water, more preferably less than 30 wt %, even more preferably less than 25 wt %, even more preferably less than 22.5 wt % and most preferably less than 20 wt %, based on the total weight of the fava protein composition.

In a further embodiment, the fava protein composition comprises at most 10 wt % of water. Preferably, the fava protein composition comprises at most 9 wt % of water, more preferably at most 8 wt %, even more preferably at most 6 wt % and most preferably at most 5 wt %, and preferably at least 0.001 wt % of water, more preferably at least 0.01 wt % and most preferably at least 0.1 wt %, based on the total weight of the fava protein composition.

The fava protein composition of the invention can be in any form known in the art. The fava protein composition may be liquid or may be solid. When liquid, solvents can be added to dissolve or disperse the fava protein composition. Any solvent in the prior art suitable for dissolving or dispersing the fava protein composition of the invention may be used. Preferably, the solvent is a food-grade solvent, such as water, ethanol, propylene glycol or combinations thereof. The preferred solvent is water. The fava protein composition in liquid form may further comprise an antimicrobial agent. The antimicrobial agent prevents bacteria and fungi to grow in the liquid composition. Examples of such antimicrobial agents include acids such as lactic acid, butyric acid and acetic acid; or conventional preservatives such as phenoxyethanol.

In an embodiment wherein the fava protein composition is liquid, the fava protein composition may comprise water in an amount of at most 99 wt %, based on the total weight of the fava protein composition. Preferably, water is present in an amount of at most 95 wt %, more preferably at most 90 wt %, even more preferably at most 80 wt % and most preferably at most 70 wt %, and preferably at least 1 wt %, more preferably at least 2 wt %, even more preferably at least 5 wt % and most preferably at least 10 wt %, based on the total weight of the fava protein composition.

The fava protein composition in liquid form may further comprise salts, pigments and dyes, fragrances or flavoring agents, etc.

When in solid form, the fava protein composition may be in powder form or in the form of larger particles.

### Particle Comprising the Fava Protein Composition

The invention further pertains to a particle comprising the fava protein composition according to the first aspect or obtainable by the method according to the second aspect as defined infra. It was found that particles of the fava protein composition can be easily prepared using conventional drying methods, including spray drying and fluidized bed drying techniques. In one embodiment, the particles are spherical, i.e. they have a spherical or near spherical shape. The particles of the invention are generally free flowing, resulting in a better processability of the fava protein composition. Also the storage stability of the fava protein composition is improved. Generally, no preservatives need to be added for good storage stability. Moreover, the water activity of the particles is so low (preferably below 0.6) that no microbial growth is observed upon storage. The disintegration and dispersing of the fava protein composition in a solvent, in particular in water, may generally be faster compared to a powder of the fava protein.

In one embodiment, the particle predominantly comprises the fava protein composition as defined hereinbefore. Preferably, the particle comprises at least 50 wt % of the fava protein composition of the invention, more preferably at least 60 wt %, even more preferably at least 70 wt % and most preferably at least 80 wt %, and preferably at most 99 wt % of the fava protein composition of the invention, more preferably at most 97 wt % and most preferably at most 95 wt %, based on the total weight of the particle.

In a further embodiment, the particle comprises at most 15 wt % of water. Preferably, the particle comprises at most 12 wt % of water, more preferably at most 10 wt %, even more preferably at most 8 wt % and most preferably at least 5 wt %, and preferably at least 0.001 wt % of water, more preferably at least 0.01 wt % and most preferably at least 0.1 wt %, based on the total weight of the particle.

In one embodiment, the particles have a d50 value of at most 1000 μm. Preferably, the particles have a d50 value of at most 800 μm, more preferably a d50 value of at most 600 μm, and most preferably a d50 value of at most 500 μm, and preferably a d50 value of at least 50 μm, more preferably at least 100 μm and most preferably at least 200 μm.

The remaining part of the particle may be comprised of other components commonly used in particles comprising fava protein, such as excipients like disintegrating agents, pigments or dyes, etc. The fava protein composition, water and the other components add up to 100 wt % of the total weight of the particle.

### Emulsion Comprising the Fava Protein Composition

The invention further pertains to an emulsion comprising water, oil and the fava protein composition according to the first aspect or obtainable by the method according to the second aspect as defined infra. The emulsion can be any emulsion known in the art. The emulsion of the invention comprises at least two liquids and can be an oil-in-water emulsion. Preferably, the emulsion is an oil-in-water emulsion. The fava protein composition according to the first aspect generally emulsifies and stabilizes the oil droplets in the water matrix. The amount of fava protein composition in the emulsion is generally lower than conventional bio-based protein-containing emulsifiers (such as gum Arabic). Also the amount of oil (or water) used can be high (e.g. above 50 wt % oil in the emulsion). Due to the pH stability of the fava protein composition, emulsions can be prepared at different pH values, including emulsions where lowering to a low pH (e.g. below a pH of 5) and subsequent increase of pH (above 6) are applied. As the fava protein composition according to the first aspect is bio-based, non-toxic and biodegradable, the fava protein composition can be used in food-grade applications, such as dressings, sauces and mayonnaise.

The oil suitable in the emulsion of the invention is any oil or hydrophobic liquid known in the art. Examples of such oils include hydrocarbon oils such as mineral oil fractions comprising linear mineral oils (n-paraffins), branched mineral oils (iso-paraffinic) and/or cyclic mineral oils (naphthenic oils); polyisobutylenes (PIB), phosphate esters such as trioctyl phosphate; polyalkylbenzenes such as heavy alkylates, dodecyl benzene and other alkylarenes; esters of aliphatic monocarboxylic acids; linear or branched mono unsaturated hydrocarbons such as linear or branched alkanes containing 8 to 25 carbon atoms and linear or branched alkenes containing 8 to 25 carbon atoms; natural flavor and/or fragrance oils such as essential oils, jojoba oil and flavor oils derived from citrus peel; and natural oils such as palm oil, soybean oil, olive oil, sunflower oil, rapeseed oil and castor oil.

In an embodiment of an oil-in-water emulsion, the emulsion comprises the oil in an amount of at most 90% wt %, based on the total weight of the emulsion. Preferably, the oil is present in an amount of at most 85 wt %, more preferably at most 80 wt %, even more preferably at most 70 wt % and most preferably at most 60 wt %, and preferably at least 1 wt %, more preferably at least 2 wt %, even more preferably at least 5 wt % and most preferably at least 10 wt %, based on the total weight of the emulsion.

In an embodiment of an oil-in-water emulsion, the emulsion comprises water in an amount of at least 10 wt %, based on the total weight of the emulsion. Preferably, water is present in an amount of at least 15 wt %, more preferably at least 20 wt %, even more preferably at least 30 wt % and most preferably at least 40 wt %, and preferably at most 99 wt %, more preferably at most 98 wt %, even more preferably at most 95 wt % and most preferably at most 90 wt %, based on the total weight of the emulsion.

The fava protein composition of the invention can be chosen according to need in amounts as desired. The emulsion of the invention, preferably the oil-in-water emulsion, may comprise the fava protein composition in an amount of at most 10 wt %, based on the total weight of the emulsion. Preferably, the fava protein composition is present in an amount of at most 8 wt %, more preferably at most 5 wt %, even more preferably at most 2 wt % and most preferably at most 1 wt %, and preferably at least 0.01 wt %, more preferably at least 0.05 wt %, even more preferably at least 0.1 wt % and most preferably at least 0.2 wt %, based on the total weight of the emulsion.

The remaining part of the emulsion may be comprised of other components commonly used in emulsions such as salts, preservatives, pigments and dyes, fragrances or flavoring agents, etc. The oil, water, fava protein composition and the other components add up to 100 wt % of the total weight of the emulsion.

The emulsions of the invention can be used in food application, paints, construction applications, textiles e.g. fiber treatment, leather lubrication, household care compositions, softening, fabric care in laundry applications, healthcare applications, release agents, water-based coatings and personal care or cosmetic applications. The cosmetic applications include those that are intended to be placed in contact with portions of the human body (skin, hair, nails, mucosa, etc.) or with teeth and the mucous membranes of the oral cavity with a view exclusively or mainly to cleaning them, perfuming them, changing their appearance, protecting them, keeping them in good condition or modifying odors, and skin care, sun care, hair care or nail care applications. Consequently, the present invention further pertains to emulsions of the invention, in particular oil-in-water emulsions, for use in creams, ointments, unguents, gels, pastes, liniments, foams, transdermal patches, lotions and topical solutions.

### Dispersion Comprising the Fava Protein Composition

The invention further pertains to a dispersion comprising the fava protein composition according to the first aspect or obtainable by the method according to the second aspect as defined infra, a solvent and solid particles. The fava protein composition serves as a dispersant, enabling solid particles to remain in the solvent rather than settling on the bottom. The inventors found that the fava protein composition according to the first aspect can form and stabilize dispersions of solids, in particular inorganic solid particles. It is also envisaged that the fava proteins may be chemically linked to the surface of the solid particles.

In an embodiment, the dispersion may comprise the fava protein composition in an amount of at most 10 wt %, based on the total weight of the dispersion. Preferably, the fava protein composition is present in an amount of at most 8 wt %, more preferably at most 5 wt %, even more preferably at most 2 wt % and most preferably at most 1 wt %, and preferably at least 0.01 wt %, more preferably at least 0.05 wt %, even more preferably at least 0.1 wt % and most preferably at least 0.2 wt %, based on the total weight of the dispersion.

The solid particles or solids may be any solid particle known in the art and which can be suitably used in dispersions. The solid particles of the invention may be selected from polymeric particles, oxide and/or hydroxide particles, pigments and fillers.

Examples of polymeric particles include polyolefins such as polystyrene, polyethylene and polypropylene; polyesters such as polyacrylate and polymethyl methacrylate.

Examples of oxide and/or hydroxide particles include oxides and hydroxides of aluminum, silicium, boron, sodium, potassium, calcium, iron, nickel, cobalt, titanium, zirconium, cerium, chromium, zinc, tin and tungsten. Preferably, the oxide and/or hydroxide particles are oxides and/or hydroxides selected from aluminum, silicium, calcium, titanium and iron.

Examples of pigments include metal-based pigments, inorganic pigments and biological and organic pigments. Examples of metal-based pigments include cadmium pigments such as cadmium yellow cadmium green, cadmium orange, cadmium sulfoselenide and cadmium red; cobalt pigments such as cobalt violet, cobalt blue, aureolin and cerulean blue; chromium pigments such as chrome yellow and chrome green (viridian); copper pigments such as azurite, Han purple, Han blue and Egyptian blue; iron oxide pigments such as sanguine, caput mortuum, red ochre, Venetian red and Prussian blue; lead pigments such as lead white, Naples yellow, red lead and lead-tin-yellow; manganese pigments such as manganese violet and YInMn blue; mercury pigments such as vermillion; titanium pigments such as titanium yellow, titanium beige, titanium white and titanium black; and zinc pigments such zinc white, zinc ferrite and zinc yellow. Examples of (non-metal-based) inorganic pigments include carbon pigments such as carbon black and ivory black and clay earth pigments such as yellow ochre, raw sienna, burnt sienna, raw umber and burnt umber; and ultramarine pigments such as ultramarine and ultramarine green shade. Examples of biological pigments include alizarin, alizarin crimson, gamboge, cochinal red, rose madder, indigo, indian yellow and Tyrian purple. Examples of organic pigments include quinacridone, magenta, phthalo green, phthalo blue, pigment red 170 and diarylide yellow.

Examples of fillers include calcium carbonates such as ground calcium carbonate (GCC) and precipitated calcium carbonate (PCC), kaolin, carbon black, talc, bentonite, hydrotalcite and hydrotalcite-like clays, diatomite, limestone, titanium dioxide, wood flour, saw dust, calcium sulphate, aluminum trihydrate, aluminum silicate and silica.

In an embodiment, the dispersion comprises the solid particles in an amount of at most 60 wt %, based on the total weight of the dispersion. Preferably, the solid particles are present in an amount of at most 50 wt %, more preferably at most 40 wt %, even more preferably at most 30 wt % and most preferably at most 25 wt %, and preferably at least 1 wt %, more preferably at least 2 wt %, even more preferably at least 5 wt % and most preferably at least 10 wt %, based on the total weight of the dispersion.

In an embodiment, the solid particles have a d90 value of at most 100 μm, preferably at most 50 μm, more preferably at most 20 μm, even more preferably at most 10 μm, even more preferably at most 5 μm, and most preferably at most 1 μm, and at least 10 nm, preferably at least 20 nm, more preferably at least 50 nm and most preferably at least 100 nm.

In another embodiment, the solid particles have a d99 value of at most 100 μm, preferably at most 50 μm, more preferably at most 20 μm, even more preferably at most 10 μm, even more preferably at most 5 μm, and most preferably at most 1 μm, and at least 10 nm, preferably at least 20 nm, more preferably at least 50 nm and most preferably at least 100 nm.

The dispersion further comprises a solvent. The solvent can be any solvent known in the art and suitable for use in dispersions. Examples of solvents include water; alcohols such as ethanol and isopropanol; alkanes such as pentane and hexane; ketones such as methyl ethyl ketone (MEK), acetone and methyl propyl ketone; and aromatic solvents such as toluene and benzene. In a preferred embodiment, the dispersion comprises water as solvent. Especially, the solvents other than water increase the amount of volatile organic compounds (VOC). Therefore, dispersions of the invention are preferred that only comprise water as solvent.

In one embodiment, the dispersion may comprise water (or another solvent) in an amount of at most 90 wt %, based on the total weight of the dispersion. Preferably, water is present in an amount of at most 80 wt %, more preferably at most 70 wt %, even more preferably at most 60 wt % and most preferably at most 50 wt %, and preferably at least 1 wt %, more preferably at least 2 wt %, even more preferably at least 5 wt % and most preferably at least 10 wt %, based on the total weight of the dispersion.

The remaining part of the dispersion may be comprised of other components commonly used in dispersions. The solid particles, the solvent, the fava protein composition and the other components add up to 100 wt % of the total weight of the dispersion.

### Method of Extracting Fava Proteins

In a second aspect, the invention pertains to a method of extracting fava proteins from de-hulled fava beans, said method comprising the steps of:
(a) milling de-hulled fava beans to form fava bean particles;
(b) adding water to the fava bean particles to form a suspension;
(c) removing solids from the suspension to form a liquid;
(d) subjecting the liquid to ultrafiltration to form a retentate;
(e) optionally pasteurizing the retentate; and
(f) optionally removing water from the retentate, preferably to form solid particles.

With the method of the invention, the fava protein composition according to the first aspect can be prepared. Accordingly, in an embodiment, the fava protein composition according to the first aspect is obtained by or obtainable by the process according to the second aspect.

The method according to the second aspect starts with milling de-hulled fava beans. Hence, fava beans are de-hulled, i.e. the seed coat is removed. De-hulling of the fava beans can be carried out using any conventional means and process known in the art. The seed coat comprises phenols, polyphenols, saponins and tannins which can cause upon oxidation discoloration of the fava protein composition and the oxidized compounds may interact with the proteins, which means that these oxidized compounds cannot be easily removed. The embryo radicle contains 10 times more vicine and convicine than the cotyledon, and removal of the embryo radicle is advantageous to lower the vicine and convicine content in the fava protein composition of the invention.

The de-hulled fava beans are milled in step (a) of the method. Milling can be performed using any milling method and mill known in the art and suitable for milling fava beans. The milling causes the fava bean to become a powder comprising fava bean particles with a desired particle size distribution.

In an embodiment of the invention, the fava bean particles have a d90 value of at most 900 μm, preferably at most 800 μm, more preferably at most 700 μm, even more preferably at most 600 μm, yet more preferably at most 500 μm, and most preferably at most 400 μm, and at least 1 μm, preferably at least 2 μm, more preferably at least 5 μm and most preferably at least 10 μm.

In step (b) of the method, water is added to the fava bean particles to form a suspension. In an embodiment, an amount of water is added to provide a suspension having between 3 and 30 wt % of fava bean particles, based on the total weight of the suspension, preferably between 5 and 20 wt %, more preferably between 8 and 15 wt %.

In step (b), water-soluble ingredients are extracted from the fava bean particles. The temperature of the suspension is maintained above room temperature. Preferably, the temperature of the suspension during step (b) is maintained at a value of at least 25° C., more preferably at least 30° C., more preferably at least 35° C. and most preferably at least 40° C., and preferably at most 80° C., more preferably at most 75° C., and most preferably at most 70° C. The temperature is chosen such that the solubility of the proteins in the composition is maximized and microbes do not grow or grow very slowly. These microbes may form toxins when the colony will be too abundant. Therefore, the temperature is chosen in order to avoid toxin expression.

In another preferred embodiment, the pH of the suspension during step (b) is at most 9, more preferably at most 8.5, even more preferably at most 8, and most preferably at most 7.5, and preferably at least 5, more preferably at least 5.5, even more preferably at least 6 and most preferably at least 6.5. A pH above 6, particularly if a browning inhibitor is absent in the suspension, is generally disadvantageous as oxidation of phenols and/or polyphenols may occur which may bind to the protein and colour the fava protein composition yellow to brown. Moreover, at higher pHs, lysinoalanine (LAL) can be formed more pronouncedly. A pH below 6 may cause precipitation of the fava protein, in particular the globulins in the fava protein, which alters the emulsification and solubility properties of the resulting fava proteins.

In an embodiment, a browning inhibitor may be added to the suspension in step (b). Browning is generally caused by enzymatic and/or auto-oxidation of polyphenols. The browning inhibitor serves to inhibit or even prevent the oxidation of polyphenols. The browning inhibitor can be any browning inhibitor known in the art. Examples of such inhibitors include ascorbic acid, L-cysteine, glutathione, sulfites such as sodium bisulfite, troplone, kojic acid, L-mimosine, arbutin and cinnamic acid.

The browning inhibitor may be present in an amount of at most 5 wt %, based on the total weight of the suspension.

Preferably, the browning inhibitor is present in an amount of at most 3 wt %, more preferably at most 2 wt %, even more preferably at most 1 wt % and most preferably at most 0.5 wt %, and preferably at least 0.01 wt %, more preferably at least 0.05 wt %, even more preferably at least 0.1 wt % and most preferably at least 0.2 wt %, based on the total weight of the suspension.

In step (c) of the method, the solids are removed from the suspension in order to separate the solids from the supernatant liquid. The liquid generally has a milk-like appearance. The removal of solids can be performed using any method known in the art. Examples of such methods include centrifugation, decantation and filtration. The supernatant liquid comprises the fava bean protein, and the solids generally comprise insoluble fibers and polysaccharides (in particular starch).

The temperature of the suspension during step (c) is maintained above room temperature. Preferably, the temperature of the suspension during step (c) is maintained at a value of at least 25° C., more preferably at least 30° C., more preferably at least 35° C. and most preferably at least 40° C., and preferably at most 80° C., more preferably at most 75° C., and most preferably at most 70° C. Preferably, the temperature of the suspension in step (c) is the same as the temperature of the suspension in step (b).

In another preferred embodiment, the pH of the suspension in step (c) is at most 8.5, more preferably at most 8, and most preferably at most 7.5, and preferably at least 5, more preferably at least 5.5, even more preferably at least 6 and most preferably at least 6.5. It is envisaged to adjust the pH during step (c) when necessary. Preferably, the pH of the suspension in step (c) is the same as the temperature of the suspension in step (b).

In step (d) of the method, the supernatant liquid is subsequently subjected to ultrafiltration, in particular ultrafiltration with a membrane having a MWCO (molecular weight cut off) of at most 500 kDa. As will be appreciated by those skilled in the art, the term ‘ultrafiltration’ as used herein concerns cross-flow membrane filtration using an ultrafiltration membrane. In dead-end filtration, the pore size of the membrane (often expressed in kDa) determines which molecules cross the membrane into the permeate and which molecules cannot and remain in the retentate. In cross-flow membrane filtration, the situation is different. The feed stream to be filtrated flows in a direction parallel to the membrane. The shear close to the membrane is low, whereas it is higher farther away from the membrane. As a result of the lower shear close to the membrane, a fouling or boundary layer may develop on top of the membrane. Said fouling or boundary layer influences which molecules can cross the membrane and which molecules cannot. In other words, the pore size of a membrane operated in a cross-flow filtration mode may retain molecules in the retentate that are much smaller than the pore size.

The membrane used can be any suitable membrane known in the art and suitable for ultrafiltration. Examples of suitable materials for such membranes include polyether sulfones, polysulfones, ceramic membranes and polyvinylidene difluoride. Preferably, the MWCO is at most 300 kDa, more preferably at most 200 kDa, even more preferably at most 150 kDa and still preferably at most 125 kDa, such as at most 100 kDa, at most 80 kDa, at most 60 kDa, at most 50 kDa, at most 40 kDa, at most 35 kDa or at most 30 kDa, and preferably at least 5 kDa, more preferably at least 10 kDa and most preferably at least 20 kDa.

Depending on the conditions of ultrafiltration (flow rate, temperature, MWCO and type of membrane), minerals, monosaccharides and/or oligosaccharides, polyphenols, vicine, convicine and hexanal (and other off-flavour components) are effectively separated from the fava protein composition and removed through the permeate. In step (d), preferably both the albumins and globulins, more preferably all the albumins and globulins, present in the liquid that is subjected to ultrafiltration are maintained in the retentate.

The temperature of the supernatant liquid during step (d) is maintained at above room temperature. Preferably, the temperature of the supernatant liquid during step (d) is maintained at a value of at least 25° C., more preferably at least 30° C., more preferably at least 35° C. and most preferably at least 40° C., and preferably at most 80° C., more preferably at most 75° C., and most preferably at most 70° C. Preferably, the temperature of the supernatant liquid in step (d) is the same as the temperature applied in step (b) and/or step (c).

In another preferred embodiment, the pH of the liquid that is subjected to ultrafiltration in step (d) is at most 8.5, more preferably at most 8, and most preferably at most 7.5, and preferably at least 5, more preferably at least 5.5, even more preferably at least 6 and most preferably at least 6.5. It is envisaged to adjust the pH during step (d) when necessary. Preferably, the pH of the supernatant liquid in step (d) is the same as the pH applied in step (b) and/or step (c).

The concentration factor in step (d) is preferably between 1.2 and 10, such as between 1.5 and 8, between 4 and 8, between 1.5 and 4, between 4 and 6 or between 1.5 and 2.

In a preferred embodiment, ultrafiltration step (d) is performed as diafiltration. The inventors have established that diafiltration can be advantageously applied to further lower the hexanal content. As will be appreciated by those skilled in the art, the term ‘diafiltration’ as used herein concerns cross-flow membrane filtration. In this step, water is generally added to the retentate while the retentate is filtered using the ultrafiltration membrane in order to remove small molecules. In a preferred embodiment wherein ultrafiltration step (d) is performed as diafiltration, the diafiltration factor (W/F) is between 1 and 8, more preferably between 1.5 and 6, such as between 2 and 5 or between 2 and 2.5.

In a very preferred embodiment, the retentate obtained in step (d), not already performed as diafiltration, is subjected to an additional diafiltration step (d2). The diafiltration step can be carried out using any diafiltration technique known in the art. In this step, water is generally added to the retentate while the retentate is filtered using a membrane in order to remove small molecules. In a preferred embodiment the concentration factor in step (d) is between 1.2 and 10, such as between 1.5 and 8, between 4 and 8, between 1.5 and 4, between 4 and 6, or between 1.5 and 2 and the diafiltration factor (W/F) in diafiltration step (d2) is between 1 and 8, more preferably between 1.5 and 6, such as between 2 and 5 or between 2 and 2.5.

The membrane can be any membrane known in the art and suitable for diafiltration. Examples of suitable materials for such membranes include polyether sulfones, polysulfones, ceramic membranes and polyvinylidene difluoride. Preferably, the MWCO is at most 500 kDa, more preferably at most 300 kDa, even more preferably at most 200 kDa, even more preferably at most 150 kDa and still preferably at most 125 kDa, such as at most 100 kDa, at most 80 kDa, at most 60 kDa, at most 50 kDa, at most 40 kDa, at most 35 kDa or at most 30 kDa, and preferably at least 5 kDa, more preferably at least 10 kDa and most preferably at least 15 kDa. Depending on the conditions of diafiltration (flow rate, amount of water added, temperature, MWCO and type of membrane), minerals, monosaccharides and/or oligosaccharides, polyphenols, vicine, convicine and hexanal (and other off-flavour components) are effectively separated from the fava protein composition and removed through the permeate. In step (d2), preferably both the albumins and globulins, more preferably all the albumins and globulins, present in the retentate that is subjected to diafiltration are maintained in the retentate. It is envisaged that the membrane used for ultrafiltration is the same as the membrane used for diafiltration.

The temperature of the retentate liquid during the diafiltration step is maintained at above room temperature. Preferably, the temperature of the retentate liquid during step (d2) is maintained at a value of at least 25° C., more preferably at least 30° C., more preferably at least 35° C. and most preferably at least 40° C., and preferably at most 80° C., more preferably at most 75° C., and most preferably at most 70° C. Preferably, the temperature of the retentate liquid in this step is the same as the temperature applied in step (b), (c) and (d).

In another preferred embodiment, the pH of the retentate liquid in the diafiltration step (d2) is at most 8.5, more preferably at most 8, and most preferably at most 7.5, and preferably at least 5, more preferably at least 5.5, even more preferably at least 6 and most preferably at least 6.5. It is envisaged to adjust the pH during this step when necessary. Preferably, the pH of the retentate liquid in this step is the same as the pH applied in step (b), (c) and (d).

The method according to the second aspect further comprises an optional pasteurization step (e) of the retentate obtained in step (d) or (d2). In an embodiment, the water content of the retentate is first reduced before subjecting it to pasteurization, for example to between 20 and 40 wt % using evaporation. Pasteurization can be performed with any method known in the art. Typically, the pasteurization step is carried out at a temperature of 70° C. or higher. The time of pasteurization depends on the temperature chosen. A skilled person will understand that the higher the pasteurization temperature a shorter exposure time is needed. For example, the retentate can be pasteurized at 70° C. for 2 minutes, or alternatively at 80° C. for 12 seconds or at 90° C. for 2 seconds. The pasteurization is intended to significantly reduce the microbial activity of the fava protein composition without denaturing (or hardly denaturing) the fava protein.

In an embodiment, the pH of the retentate liquid to be pasteurized in step (e) is at most 8.5, more preferably at most 8, and most preferably at most 7.5, and preferably at least 5, more preferably at least 5.5, even more preferably at least 6 and most preferably at least 6.5. It is envisaged to adjust the pH during step (e) when necessary. Preferably, the pH of the retentate liquid to be pasteurized in step (e) is the same as the pH applied in steps (b), (c), (d) and optionally step (d2).

In optional step (f), water may be at least partially removed from the retentate. Water removal can be performed using conventional techniques including membrane separation such as (reverse) osmosis and evaporation techniques such as fluidized bed drying, spray drying and evaporation through heating the resulting liquid. In this way, an aqueous liquid comprising the fava protein composition can be obtained. When the fava protein composition is dried further, dried powder or particles can be obtained.

### Uses and Applications

The fava protein composition of the invention can be used in a wide range of applications. The invention pertains to the use of the fava protein composition in food applications, paints, construction applications, textiles e.g. fiber treatment, leather lubrication, household care compositions, softening, fabric care in laundry applications, healthcare applications, release agents, water-based coatings, personal care or cosmetic applications, emulsion polymerizations, carpeting, automobile parts, window frames, kitchen worktops, container closures, lunch boxes, closures, medical devices, household articles, food containers, dishwashers, outdoor furniture, blow-molded bottles, disposable non-woven fabrics, cables and wires, packaging, coil coating applications, can coatings, car refinish, mining, oil drilling, fuel additive and automotive applications. Each of these uses is separately contemplated and is meant to be explicitly and individually disclosed.

The invention further concerns the following embodiments (A) to (J):
(A) A fava protein composition comprising globulins and albumins; and comprising at most 10 ppm hexanal.
(B) Composition according to embodiment (A), comprising at most 1 ppm hexanal.
(C) Composition according to any one of embodiment (A) and (B), wherein the solubility of the FAVA protein in water and at a pH of 3 is at least 50 wt %, based on the total weight of the composition.
(D) Composition according to any one of embodiments (A) to (C), wherein the composition comprises at least 5 wt % albumin, based on the total weight of the composition.
(E) Composition according to any one of embodiments (A) to (D), wherein the solubility of the FAVA protein in water and at a pH of 7 is at least 50 wt %, based on the total weight of the composition.
(F) Composition according to any one of embodiments (A) to (E), wherein the composition comprises at least 10 wt % of native protein, based on the total weight of the composition.
(G) Composition according to any one embodiments (A) to (F), wherein the composition comprises at most 10 wt % water.
(H) A method of extracting fava proteins from de-hulled fava beans comprising the steps of:
(a) milling de-hulled fava beans to form fava bean particles;
(b) adding water to the fava bean particles to form a suspension;
(c) removing solids from the suspension to form a liquid;
(d) subjecting the liquid to ultrafiltration to form a retentate; and
(e) removing water from the retentate to form solid particles.
(I) An emulsion comprising water, oil and the fava protein composition according to any one of embodiments (A) to (G).
(J) A dispersion comprising a solvent, solid particles and the fava protein composition according to any one of embodiments (A) to (G).

Thus, the invention has been described by reference to certain embodiments discussed above. It will be recognized that these embodiments are susceptible to various modifications and alternative forms well known to those of skill in the art.

Furthermore, for a proper understanding of this document and its claims, it is to be understood that the verb ‘to comprise’ and its conjugations are used in its non-limiting sense to mean that items following the word are included, but items not specifically mentioned are not excluded. In addition, reference to an element by the indefinite article ‘a’ or ‘an’ does not exclude the possibility that more than one of the element is present, unless the context clearly requires that there be one and only one of the elements. The indefinite article ‘a’ or ‘an’ thus usually means ‘at least one’.

The invention is exemplified in the following Examples.

### EXAMPLES

### Measuring Protocols

### Method for Measuring the Hexanal Content

The hexanal content in fava protein compositions was determined as follows. Gas chromatography-mass spectrometry with solid phase microextraction (GC-SPME-MS) was used to quantify the hexanal. About 1 gram of a sample of a fava protein composition was placed in a GC headspace vial. The sample was mixed with 4 ml of Milli-Q water, 100 μL of acetonitrile (final concentration 20 ppm) and 2 gram of NaCl salt. Subsequently, the sample in the vial was vortexed and placed in a sample holder of the GC. Solid-Phase Microextraction (SPME, using the following SPME fiber: 50/30 μm DVB/CAR/PDMS, Stableflex, 23Ga, from Supelco) was used to extract the hexanal from the samples. The extraction was conducted for 15 minutes at 60° C. A Stabilwax 60 meter, 0.32 mm ID, 0.5 μm df column (Restek) was used as GC column with the following conditions: helium as carrier gas with a flow rate of 1.5 ml/min, column temperature was set for the first two minutes (0-2 min.) at 50° C. Subsequently, the column temperature was increased from 50 to 250° C. over a total run time of 14.5 minutes (2-16.5 min.). Hence, the total run time was 16.5 minutes. Following the extraction and injection of hexanal, ionization together with mass spectrometry were used to identify the peak(s). Commercial hexanal standard was purchased from Sigma Aldrich and different ranges of concentrations were used to depict the calibration curve. The ionization mode was based on Electron Ionization (EI). The temperature of MS transfer line and ion source were 250° C. and 290° C., respectively. The masses of 56 and 72 were used to quantify and qualify the hexanal peak, respectively. The resulting hexanal content of the fava protein composition was based on the total weight of the fava protein composition (wet weight). If the dry weight of the sample is known, the hexanal content in a fava protein composition can be expressed based on dry matter of the fava protein composition. If the total protein content of the fava protein composition is known, the hexanal content in a fava protein composition can be expressed based on the weight of the protein in the fava protein composition. If the total fava protein content of the fava protein composition is known, the hexanal content in a fava protein composition can be expressed based on the weight of the fava protein in the fava protein composition. Likewise, if the combined amount of the fava globulins and fava albumins of the fava protein composition is known, the hexanal content in a fava protein composition can be expressed based on the weight of the combined amount of the fava globulins and fava albumins.

### Kjeldahl Method

The Kjeldahl method was performed by hydrolysing a sample using H₂SO₄ at 420° C. for 2 hours, during which the proteins will be converted to ammonia. The generated ammonia is distilled off and the amount of nitrogen is measured by titration. The amount of protein is calculated by multiplying the nitrogen content by the conversion factor of 6.25 (nitrogen to protein factor).

Method for Measuring the Protein Solubility at pH=7 or pH=3 and T=20° C.

The aqueous solubility of protein at pH=7 (or pH=3) and at a temperature of 20° C. was tested using the following protocol:
(a) a sample of fava protein composition is added to demineralized water in an amount of 2 wt %, based on the total weight of all ingredients;
(b) the composition of step (a) is stirred for one hour at a temperature of 20° C.;
(c) the pH of the composition obtained in step (b) is measured;
(d) if the pH measured in step (c) differs from 7 (or 3), the pH is adjusted to 7 (or 3) with 1 M HCl or 1 M NaOH;
(e) a first subsample of the composition obtained in step (d) is taken and the total protein content (A) is determined (g/L) using the Kjeldahl method with a conversion factor of 6.25;
(f) a second subsample of the composition obtained in step (d) is taken, is centrifuged for 10 minutes at 4000 G (Beckman Coulter Avanti J-E centrifuge), the resulting supernatant is isolated and its total protein content (B) is determined (g/L) using the Kjeldahl method with a conversion factor of 6.25;
(g) the solubility of the protein is calculated at pH=7 (or 3) and T=20° C. from:

% Solubility=(B)/(A)·100%.

Method for Measuring the Solubility of the Fava Protein Composition at pH=7 or pH=3 and T=20° C.

The aqueous solubility of a fava protein composition at pH=7 (or pH=3) and at a temperature of 20° C. was tested using the following protocol:
(a) a sample of the fava protein composition is added to demineralized water in an amount of (A) gram, to prepare a 2 wt % mixture, based on the total weight of all ingredients;
(b) the mixture of step (a) is stirred for one hour at a temperature of 20° C.;
(c) the pH of the composition obtained in step (b) is measured;
(d) if the pH measured in step (c) differs from 7 (or 3), the pH is adjusted to 7 (or 3) with 1 M HCl or 1 M NaOH;
(e) the composition obtained in step (d) is centrifuged for 10 minutes at 4000 G (Beckman Coulter Avanti J-E centrifuge) followed by separation of the pellet fraction and supernatant;
(f) the pellet fraction is dried in a vacuum oven and the weight (B) in gram of the dried pellet fraction is measured.
(g) the solubility of the fava protein composition is calculated at pH=7 (or 3) and T=20° C. from:

wt % Solubility=[(A)−(B)]/(A)·100 wt %.

### Example 1

1.5 kg of fava bean flour from de-hulled fava beans was dispersed in water. The pH was adjusted to 7.0 using a 1 M NaOH solution, and the temperature of the resulting suspension was maintained at 45° C. To the suspension, sodium bisulfite was added to a concentration of 0.1 wt %. The resulting suspension had a concentration of the fava bean flour of 10 wt %. The suspension was subsequently centrifuged in a rotor centrifuge (8,000 g for 10 min). The supernatant liquid was separated from the solid cake by decantation. The pH and temperature were maintained at 7.0 and 45° C., respectively. The supernatant liquid was run over an ultrafiltration membrane (Ceramic, MWCO is 25 kDa). The volume-to-concentration factor was 2. The retentate liquid was subsequently concentrated to 25 wt % dry matter by evaporation at 60° C. and a pressure of 120 mbar. The concentrated liquid was pasteurized at 70° C. for 2 minutes, and subsequently spray dried to form a white powder.

The fava protein powder contained 91.0 wt % protein as measured using the Kjeldahl method (vide supra). The amount of water was determined at 2.5 wt %, and the sugar, fat and ash content were 0.8 wt %, 0.6 wt % and 5.1 wt %, respectively.

The solubility of the fava protein powder at 2 wt % in water at a pH of 3 and at a temperature of 20° C. was 90 wt %, and was 95 wt % at pH of 7 and at a temperature of 20° C. This amounts to a fava protein solubility of at least 81% at a pH of 3 and at a temperature of 20° C. and a fava protein solubility of at least 86% at a pH of 7 and at a temperature of 20° C.

### Example 2

Fava protein compositions were prepared as follows. Fava bean flour from de-hulled fava beans was dispersed in water at a concentration of A wt % (see Table 1). The pH was adjusted to B (see Table 1) using a 1 M NaOH solution and the temperature of the resulting suspension was maintained at 20° C. To the suspension, sodium bisulfite was added to a concentration of C wt % (see Table 1). The suspension was subsequently centrifuged in a rotor centrifuge (D g for E min; see Table 1). The supernatant liquid was separated from the solid cake by decantation. The supernatant liquid was subjected to membrane filtration over an ultrafiltration membrane (Sartorius VivaFlow 200, 100 kDa) to a concentration factor of F and subsequently diafiltrated using the same ultrafiltration membrane at a diafiltration factor (W/F) of G (see Table 1). The retentate liquid was spray dried to form a white powder.

The fava protein compositions contained H wt % (see Table 1) protein as measured using the Kjeldahl method (vide supra) and had a dry matter content of I wt % (see Table 1).

TABLE 1
production parameters

| Example | A | B | C | D | E | F | G | H | I |
|---|---|---|---|---|---|---|---|---|---|
| 2A | 20 | 7 | 0.1 | 4500 | 5 | 2 | 1 | 89 | 95 |
| 2B | 10 | 6.4 | 0.0 | 10000 | 10 | 4 | 2 | 93 | 93 |
| 2C | 20 | 6.4 | 0.0 | 10000 | 10 | 2 | 4 | 90 | 94 |
| 2D | 10 | 8 | 0.1 | 10000 | 10 | 4 | 2 | 90 | 94 |
| 2E | 5 | 8 | 0.1 | 10000 | 10 | 8 | 2 | 91 | 94 |

The fava protein composition obtained in Example 2A was further analyzed. The fava protein composition obtained in Example 2A had a protein content of 89 wt %, a moisture content of 5 wt %, and the sugar, fat and ash content were 2.9 wt %, 0.3 wt % and 2.8 wt %, respectively.

The amount of fava globulins was 94 wt %, based on the weight or the fava protein composition and the amount of fava albumins was 6 wt %, based on the weight or the fava protein composition. Accordingly, the weight ratio of fava albumins to fava globulins was 1:15.7. Apart from fava albumins and fava globulins, no other fava proteins were detected.

The hexanal content of the fava protein composition obtained in Example 2A was measured using the protocol as defined hereinbefore and amounted to 280 ppb of hexanal, based on the total weight of the fava protein composition. This amounts to 295 ppb of hexanal, based on dry weight of the fava protein composition, to 295 ppb of hexanal, based on the weight of the fava protein in the fava protein composition and to 295 ppb of hexanal, based on the combined weight of the fava globulins and fava albumins in the fava protein composition.

### Example 3: Hexanal-Content of Commercial Fava Bean Protein Isolates

The hexanal-content of 3 commercial fava bean protein isolates was measured using the protocol as defined hereinbefore (based on total weight). Given the non-zero moisture content of the commercial fava bean protein isolates, the hexanal content of the fava bean protein isolates based on dry weight is higher. Results are presented in Table 2.

TABLE 2
hexanal-content of commercial fava bean protein isolates

| | | | | Hexanal | Hexanal |
|---|---|---|---|---|---|
| | | | | content | content |
| | | | | [ppb, | [ppb, |
| | | Protein | Moisture | based | based |
| | | content | content | on total | on dry |
| Isolate | Supplier | [wt %] | [wt %] | weight] | weight] |
| Fava beans | Yantai T. Full | ≥90 | ≤10 | 7100 | ≥7100 |
| protein | Biotech Co., Ltd | | | | |
| Faba-tein | Hill Pharma | 90% | | 5700 | ≥5700 |
| Faba bean | AGT Food and | ≥89 | ≤10 | 3100 | ≥3100 |
| Protein 90C | ingredienst | | | | |

### Example 4: Sensory Analysis

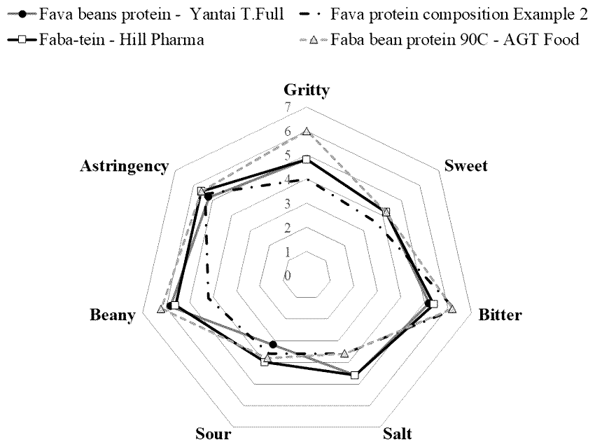

The fava protein composition according to Example 2 and the commercial fava bean protein isolates described in Table 2 of Example 3 were subjected to sensory analysis by a panel of 5 persons. Samples were prepared by preparing 2 wt % solutions of the fava protein compositions ‘as is’ in tap water. The samples were stirred at room temperature for 30 minutes. Samples were assessed based on the following characteristics: gritty, sweet, bitter, salt, sour, beany, astringency. Every characteristic was given a score between 0 and 10. The averages of the scores of the 5 panellists for each characteristic and for each fava protein composition are depicted in FIG. 1. As is immediately apparent from FIG. 1, the fava protein composition according to Example 2 has a much lower score as regards ‘beany taste’ than the commercial fava bean protein isolates.

### Example 5: Mayonnaise

A mayonnaise comprising the fava protein powder of Example 1 was prepared with the following composition (in g/100 g):
Fava protein of Example 1 1.0
Sunflower oil 70
Water 14.792
Vinegar (6% acetic acid) 10.0
Sucrose 2.0
NaCl 1.0
Lemon juice 0.8
Mustard 0.3
Potassium sorbate 0.1
EDTA 0.008

### Preparation of the Mayonnaise:

Dissolve the fava protein composition of Example 1 in water
Add dry ingredients (sugar, salt, potassium sorbate, EDTA) and mustard to protein solution
Add vinegar and lemon juice
Slowly add sunflower oil while stirring with high shear mixer (Silverson L5M-A, fine emulsor screen, 3500 rpm)
When all oil is added continue stirring at 8000 rpm for 4 minutes
Store mayonnaise in fridge

The resulting mayonnaise is a vegan mayonnaise with a smooth texture and a glossy surface. The pH of the finished product was 3.8. The fava protein, and in particular its beany and cardboard off-flavour, could not be tasted in the mayonnaise of Example 5.

### Example 6: Mayonnaise

A mayonnaise comprising the fava protein composition of Example 2 was prepared with the composition as defined in Example 5.

### Preparation of the Mayonnaise:

Combine water, vinegar and lemon juice to provide an aqueous mixture
Dissolve the fava protein composition of Example 2 in the aqueous mixture to provide a protein solution
Add dry ingredients (sugar, salt, potassium sorbate, EDTA) and mustard to the protein solution
Slowly add sunflower oil while stirring with high shear mixer (Silverson L5M-A, fine emulsor screen, 3500 rpm)
When all oil is added continue stirring at 8000 rpm for 4 minutes
Store mayonnaise in fridge

The resulting mayonnaise is a vegan mayonnaise with a smooth texture and a glossy surface. The pH of the finished product was 3.8. No beany or cardboard off-flavour could be tasted in the mayonnaise of Example 6.

### Example 7: Plant-Based Yoghurt

The fava protein composition of Example 1 and Example 2 was used in a plant-based yoghurt. Composition of the yoghurt of Example 6 (in g/100 g):
Fava protein of Example 1 or 2 6.0
Water 88.48
Dextrose monohydrate 3.0
Coconut oil 2.5
Nu-trish BY-01 0.02

The Nu-trish BY-01 is a composition comprising Streptococcus thermophilus, Lactobacillus bulgaricus and Bifidobacterium BB-12 ex Chr. Hansen.

### Preparation of the Yoghurt:

Dissolve Fava protein of Example 1 or 2 in water
Add dextrose to protein solution
Pasteurize at 80° C.; after pasteurization quickly cool down to 40° C. in ice bath
Melt coconut oil in microwave oven
Slowly add melted coconut oil to protein solution while stirring with high-shear mixer (Silverson L5M-A, fine emulsor screen, 3000 rpm). When all oil is added continue shearing for 2 more minutes
Transfer mix to fermentation vat and inoculate with LAB culture
Continue fermentation until target pH (4.6 or lower) is reached; recommended fermentation temperature: 40° C.
When target pH is reached stir/shear product to obtain a smooth appearance
Store yoghurt in the fridge.

The resulting yoghurt is a vegan yoghurt which was white with a thick and creamy texture. The yoghurt of Example 7 contains 6 wt % of the fava protein composition of Example 1 or 2, which is considerably higher than conventionally used, i.e. up to 3 wt %. The fava protein, and in particular its beany or cardboard off-flavour, could not be tasted in the yoghurt of Example 7.

1. A fava protein composition comprising:
fava globulins and fava albumins; and
at most 2.5 ppm hexanal, based on the weight of the protein in the fava protein composition,
wherein the solubility of the protein in water at a pH of 7 and at a temperature of 20° C. is at least 55%, and
wherein the weight ratio of fava albumins to fava globulins in the fava protein composition is between 1:4 and 1:20.

2. Composition according to claim 1, comprising at most 2 ppm hexanal, based on:
the weight of the fava protein; or
the combined weight of the fava globulins and fava albumins.

3. Composition according to claim 1, wherein the solubility of:
the fava protein; or
the combination of the fava albumins and fava globulins,
in water at a pH of 7 and at a temperature of 20° C. is at least 55%.

4. Composition according to claim 1, wherein the solubility of:
the protein; or
the fava protein; or
the combination of the fava albumins and fava globulins,
in water at a pH of 3 and at a temperature of 20° C. is at least 50%.

5. Composition according to claim 1, wherein the composition comprises at least 5 wt % albumin, based on the total weight of the composition.

6. Composition according to claim 1, wherein the composition comprises at least 10 wt % of native protein,
based on the total weight of the composition; or
based on the weight of the protein; or
based on the weight of the fava protein.

7. Composition according to claim 1, wherein the composition comprises at most 10 wt % water.

8. Composition according to claim 1, wherein the fava albumins constitute between 5 and 20 wt % of the proteins, in the fava protein composition.

9. Composition according to claim 1, having a dry matter content of between 91 and 99 wt %, and comprising, based on dry weight of the fava protein composition:
80-95 wt % of fava protein, such as between 82 and 88 wt %;
less than 7 wt % of fats and lipids, such as between 0.1 and 3 wt %;
less than 7 wt % of carbohydrates, such as between 0.1 and 5 wt %; and
less than 9 wt % of ash, such as between 0.1 and 6 wt %,
wherein the weight ratio of fava albumins to fava globulins in the fava protein composition is between 1:5 and 1:18.

10. Composition according to claim 1, having a dry matter content of between 91 and 99 wt %, and comprising, based on dry weight of the fava protein composition:
80-95 wt % of fava protein, such as between 82 and 88 wt %;
less than 7 wt % of fats and lipids, such as between 0.1 and 3 wt %;
less than 7 wt % of carbohydrates, such as between 0.1 and 5 wt %; and
less than 9 wt % of ash, such as between 0.1 and 6 wt %,
wherein the fava protein composition comprises more than 75 wt % of fava globulins and fava albumins, based on the weight of the fava protein composition.

11. A method of extracting fava proteins from de-hulled fava beans comprising the steps of:
(a) milling de-hulled fava beans to form fava bean particles;
(b) adding water to the fava bean particles to form a suspension;
(c) removing solids from the suspension to form a liquid;
(d) subjecting the liquid to ultrafiltration to form a retentate;
(e) optionally pasteurizing the retentate; and
(f) optionally removing water from the retentate, preferably to form solid particles.

12. Method according to claim 11, wherein ultrafiltration step (d) is performed as diafiltration step or wherein the retentate obtained in step (d) is subjected to an additional diafiltration step (d2).

13. An emulsion comprising water, oil and the fava protein composition according to claim 1.

14. (canceled)
